(19) United States
(12) Patent Application Publication
(10) Pub. No.: US 2018/0192169 A1
(43) Pub. Date: Jul. 5, 2018

(54) N-DEGREE CDC WSX ROADM

(71) Applicant: Oplink Communications US Division, LLC, Lisle, IL (US)

(72) Inventors: Tian ZHU, Castro Valley, CA (US); Kun LIU, Sunnyvale, CA (US); Hongwei MAO, Lisle, IL (US); Guijun JI, Cupertino, CA (US); Lifu GONG, San Jose, CA (US)

(73) Assignee: Oplink Communications US Division, LLC, Lisle, IL (US)

(21) Appl. No.: 15/908,223

(22) Filed: Feb. 28, 2018

Related U.S. Application Data
(62) Division of application No. 14/198,376, filed on Mar. 5, 2014.

(51) Int. Cl. H04Q 11/00; H04J 14/02; H04L 12/721

(52) U.S. Cl. CPC H04Q 11/0005; H04J 14/0204; H04J 14/0205; H04L 45/62; H04J 14/0212; H04J 14/021; H04J 14/0217

(57) ABSTRACT

An apparatus includes a plurality of ingress ports, a wavelength blocker array, a plurality of egress ports, a plurality of degree drop ports, a plurality of degree add ports, and a wavelength selective cross-connect (WSX) array. The wavelength blocker array has plurality of wavelength blocking units, each wavelength blocking unit is coupled to a corresponding one of the plurality of ingress ports. The wavelength selective cross-connect (WSX) array includes a plurality of 2×2 independently switched 2×2 wavelength selective cross-connect switches, where the WSX array is coupled to the wavelength blocker array, the plurality of egress ports, the plurality of degree drop ports, and the plurality of degree add ports.

### RELATED APPLICATIONS

This application is a divisional of U.S. application Ser. No. 14/198,376, filed Mar. 5, 2014, which is incorporated herein by reference in its entirety.

### TECHNICAL FIELD

This specification relates to optical communications.

### BACKGROUND ART

A conventional reconfigurable optical add-drop multiplexer (ROADM) is a form of optical add-drop multiplexer that additionally provides wavelength selective switching. This provides for particular wavelength channels to be added or dropped from a fiber as optical signals. ROADM's typically include a number of wavelength selective switches. A wavelength selective switch is a switch that enables optical signals with arbitrary wavelengths in, e.g., optical fibers, to be selectively switched from one optical fiber to another.

### SUMMARY

In general, one aspect of the subject matter described in this specification can be embodied in apparatuses that include multiple ingress ports coupled to N units of 1×n splitters, wherein each 1×n splitter includes multiple cross connect ingress branches and a drop branch; multiple egress ports coupled to N units of n×1 combiners, wherein each n×1 combiner includes multiple cross connect egress branches and an add branch; a M×M′ fiber shuffle providing cross connect between the ingress branches and the egress branches such that each branch from an ingress 1×n splitter is linked to a branch of each n×1 combiner; and a wavelength blocker array comprising N×n wavelength blocker units where n≥N, each wavelength blocker unit coupled to a fiber of the M×M′ fiber shuffle. Other embodiments of this aspect include corresponding systems and methods.

These and other embodiments can each optionally include one or more of the following features. The wavelength blocker array is positioned such that each wavelength blocker unit is also optically coupled to an ingress branch of one of the 1×n splitters such that each wavelength blocker unit includes an input port coupled to a corresponding ingress branch and an output port coupled to a fiber of the M×M′ fiber shuffle. Each wavelength blocker unit includes an input port coupled to the drop branches of the N units of 1×n splitters. The wavelength blocker array is positioned such that each wavelength blocker unit is also optically coupled to an egress branch of one of the n×1 combiners such that each wavelength blocker unit includes an input port coupled to a fiber of the M×M′ fiber shuffle and an output port coupled to a corresponding egress branch. Each wavelength blocker unit includes an input port coupled to the add branches of the N units of n×1 combiners. Each wavelength blocker unit is configured to selectively pass, block, or attenuate an input wavelength channel. The apparatus further includes a second wavelength blocker array coupled to the M×M′ fiber shuffle. The wavelength blocker array is coupled to the drop branches of N units of 1×n splitters and the second wavelength blocker array is coupled to the add branches of the N units of n×1 combiners. Each drop branch is coupled to one of multiple degree drop ports. The multiple degree drop ports are coupled to a twin multi-cast switch, and wherein a wavelength channel received from a particular degree drop port is selectively added by the twin multi-cast switch to a degree add port coupled to an add branch of one or more of the n×1 combiners. Each splitter is configured to separate one or more input wavelength channels to each branch and wherein a particular wavelength channel of a particular branch that is coupled to a one or more selected egress ports through the M×M′ fiber shuffle is allowed to pass through the wavelength blocker array. One or more of M or M′ is equal to N².

In general, one aspect of the subject matter described in this specification can be embodied in apparatuses that include N 1×2 ingress tap couplers, wherein a tapped branch of each ingress tap coupler is coupled to a degree drop and wherein N>1; a wavelength blocker array having N wavelength blocking units, each wavelength blocking unit coupled to a corresponding one of the N 1×2 ingress tap couplers; N 2×1 egress tap couplers, wherein a tapped branch of each egress tap coupler is coupled to a degree add; and a wavelength selective cross-connect (WSX) array coupled between the wavelength blocker array and the N 2×1 egress tap couplers, wherein the WSX array comprises multiple independently switched 2×2 WSX switches. Other embodiments of this aspect include corresponding systems and methods.

These and other embodiments can each optionally include one or more of the following features. Each wavelength blocker unit includes an input port coupled to a corresponding ingress tap coupler and an output port coupled to an input port of a particular 2×2 WSX switch. Each WSX switch includes two input ports and two output ports and wherein each WSX switch is independently controllable to switch between a bar state and a cross state, each switch state determining which input ports are coupled to which output ports. Based on a particular switch setting for the WSX array, a wavelength channel input to a first 2×2 WSX switch of the WSX array is routed through a series of the 2×2 WSX switches to a specified egress tap coupler. The WSX array includes eight 2×2 WSX switches. The WSX array includes twenty-four 2×2 WSX switches. A same wavelength channel received from different ingress tap couplers are routed by the WSX array to different egress tap couplers concurrently. A wavelength channel input at a particular ingress tap coupler can be routed to a first egress tap coupler while the same wavelength channel can be added from a degree add port and routed to a second egress tap coupler.

In general, one aspect of the subject matter described in this specification can be embodied in apparatuses that include multiple ingress ports; a wavelength blocker array having multiple wavelength blocking units, each wavelength blocking unit coupled to a corresponding one of the multiple ingress ports; multiple egress ports; multiple degree drop ports; multiple degree add ports; and a wavelength selective cross-connect (WSX) array comprising multiple 2×2 independently switched 2×2 wavelength selective cross-connect switches, wherein the WSX array is coupled to the wavelength blocker array, the multiple egress ports, the multiple degree drop ports, and the multiple degree add ports. Other embodiments of this aspect include corresponding systems and methods.

These and other embodiments can each optionally include one or more of the following features. Each wavelength blocker unit includes an input port coupled to a corresponding ingress port and an output port coupled to an input port of a particular 2×2 WSX switch. Each WSX switch includes two input ports and two output ports and wherein each WSX switch is independently controllable to switch between a bar state and a cross state, each switch state determining which input ports are coupled to which output ports. Based on a particular switch setting for the WSX array, a wavelength channel input to a first 2×2 WSX switch of the WSX array is routed through a series of the 2×2 WSX switches to a specified egress port. The WSX array includes sixteen 2×2 WSX switches. A same wavelength channel received from different ingress ports are routed by the WSX array to different egress ports concurrently. A wavelength channel received at the WSX array from a first ingress port is routed to a degree drop port and a same wavelength channel input at a degree add port is routed by the WSX array to a particular egress port. A wavelength channel received at the WSX array from a first ingress port is selectively routed to any one of the degree drop ports depending on a switch setting of the WSX array. A wavelength channel received at the WSX array from any of the ingress ports are selectively routed to a same degree drop port. A wavelength channel received at the WSX array from a first degree add port is selectively routed to any one of the egress ports depending on a switch setting of the WSX array.

In general, one aspect of the subject matter described in this specification can be embodied in apparatuses that include multiple degree drop ports; multiple degree add ports; multiple add ports; multiple drop ports; and a wavelength selective cross-connect (WSX) array comprising multiple 2×2 independently switched 2×2 wavelength selective cross-connect switches, wherein the WSX array is coupled to the multiple degree drop ports, the multiple degree add ports, the multiple drop ports, and the multiple add ports. Other embodiments of this aspect include corresponding systems and methods.

Particular embodiments of the subject matter described in this specification can be implemented so as to realize one or more of the following advantages. A wavelength blocker array (WBA) implementation of a wavelength selective cross-connect (WSX) can be less expensive and less bulky than a conventional 1×N wavelength selective switch based WSX. Additionally, a ROADM using a WBA based WSX is less bulky. The WBA also makes it easier to design devices having a higher port count, which can drive down the cost, e.g., for ROADMs. A WBA based WSX is also able to provide broadcast and drop-and-continue functionality.

A 2×2 WSX array based N.K×N.K WSX allows for an N×N WSX to be configured with a simpler structure resulting in lower cost and smaller equipment spacing. The 2×2 WSX can be integrated as an array to save cost and space. In some implementations, a 2×2 WSX array based N.K×N.K WSX can be designed to provide drop-and-continue functionality. Alternatively, in some other implementations, a 2×2 WSX array based WSX can be designed to provide a colorless and directionless add/drop port that provides increased flexibility on add and drop locations.

A twin N×N CDC add/drop shuffle has a wavelength selective function that can make multiple wavelength channels from different degrees combine to one drop port. A splitter can then be used to create more ports.

The N×N CDC add/drop shuffle can also turn unidirectional N add/drop ports into N colorless directionless and contentionless (CDC) ports, additionally using a splitter can extend N CDC ports to X (X>>N) CDC ports with very little cost. This can dramatically reduce the cost per CDC add/drop port.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B are block diagrams of an example N-degree CDC WSX ROADM.

FIG. 2A is a diagram of an example conventional N-degree WSX ROADM.

FIG. 2B is a diagram of the example N.K×N.K WSX of FIG. 2A

FIG. 2C is a diagram of the example twin N×M multicast switch of FIG. 2A.

FIG. 3A is a diagram of an example N.K×N.K WSX including a wavelength blocker array.

FIG. 3B is a diagram of the example N.K×N.K WSX of FIG. 3A with additional wavelength channel routing.

FIG. 4A is a diagram of an example 4.4×4.4 WSX using a 2×2 WSX array.

FIG. 4B is a diagram showing an example of bar and cross states of a 2×2 WSX.

FIG. 4C is a diagram of an example 8.8×8.8 WSX using a 2×2 WSX array.

FIG. 4D is a diagram of the example 4.4×4.4 WSX of FIG. 4A including example path routing.

FIG. 4E is a diagram of the example 4.4×4.4 WSX of FIG. 4A including example path routing.

FIG. 4F is a diagram of the example 4.4×4.4 WSX of FIG. 4A including example path routing.

FIG. 5A is a diagram of an example N.K×N.K WSX using a 2×2 WSX array.

FIG. 5B is a diagram of the example N.K×N.K WSX of FIG. 5A including example path routing.

FIG. 5C is a diagram of the example N.K×N.K WSX of FIG. 5A including example path routing.

FIG. 5D is a diagram of the example N.K×N.K WSX of FIG. 5A including example path routing.

FIG. 5E is a diagram of the example N.K×N.K WSX of FIG. 5A including example path routing.

FIG. 5F is a diagram of the example N.K×N.K WSX of FIG. 5A including example path routing.

FIG. 5G is a diagram of the example N.K×N.K WSX of FIG. 5A including example path routing.

FIG. 6A is a diagram of an example twin N×N CDC add/drop shuffle using a 2×2 WSX array.

FIG. 6B is a diagram of the example twin N×N CDC add/drop shuffle of FIG. 6A including example path routing.

FIG. 6C is a diagram of the example twin N×N CDC add/drop shuffle of FIG. 6A including example path routing.

FIG. 7 is a diagram of the example twin N×N CDC add/drop shuffle including a splitter extension.

Like reference numbers and designations in the various drawings indicate like elements.

### DETAILED DESCRIPTION OF THE PREFERRED EMBODIMENTS

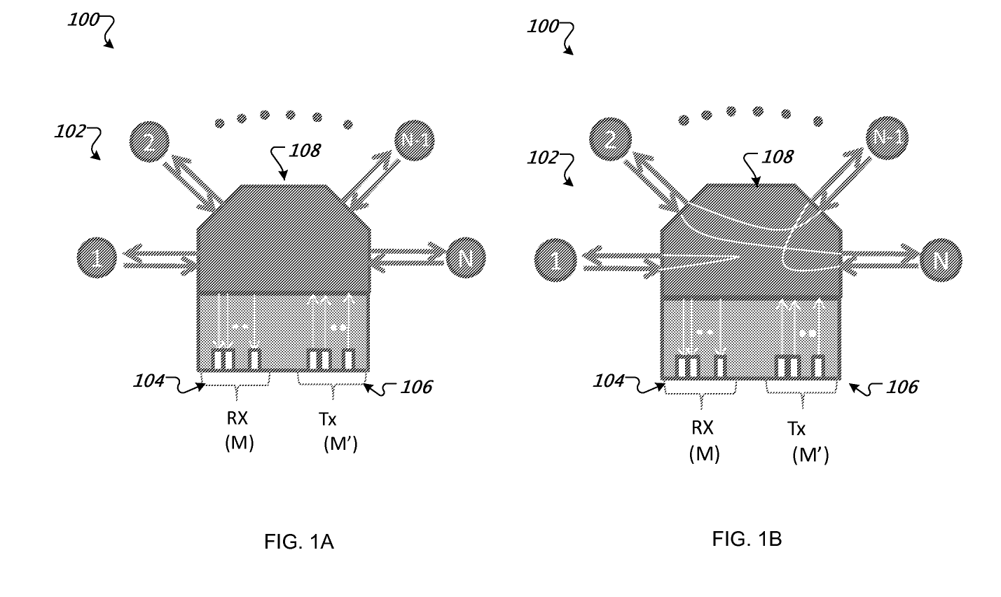

FIGS. 1A-B are block diagrams of an example N-degree colorless directionless contention (CDC) wavelength selective cross-connect (WSX) ROADM 100. The N-degree CDC WSX ROADM 100 includes N pairs of ingress and egress fibers 102 that are selectively linked together. Each pair of linked fibers is one degree. Linking a particular ingress fiber to a particular egress fiber is provided by the WSX. Each fiber can include multiple channels for optical signals. Each channel has a specific wavelength.

There are M channels of optical signal that can be dropped off from one or more ingress fibers 102 and can be converted to an electrical signal through receivers 104. Additionally, an electrical signal can be input through transmitters 106 and converted to M′ channels of optical signal that can be added to one or more of the egress fibers 102.

In operation, the optical signal from any wavelength channel input through any ingress fiber can be non-blocking switched to any of the egress fiber ports using a WSX 108. Additionally, the optical signal of any wavelength channel input through any ingress fiber can be selectively dropped to one location, e.g., one or more receivers 104. Similarly, an optical signal of a particular wavelength channel input through one or more transmitters 106 can be added to a selected egress fiber. Therefore, the adding and dropping provided by the CDC WSX ROADM 100 is colorless and directionless. Additionally, the adding or dropping of a particular wavelength channel from one optical fiber does not block the adding or dropping of wavelength channels from the other optical fibers. Thus, the CDC WSX ROADM 100 is also contentionless.

The CDC WSX ROADM 100 has three main portions: the WSX 108, which links among degrees, e.g., particular ingress fibers to particular egress fibers 102; add/drop links among ingress/egress fibers to drop/add ports; and the transmitter/receiver 106/108 that converts signals between optical and electrical states. Each of these portions is described in greater detail below with respect to particular implementations.

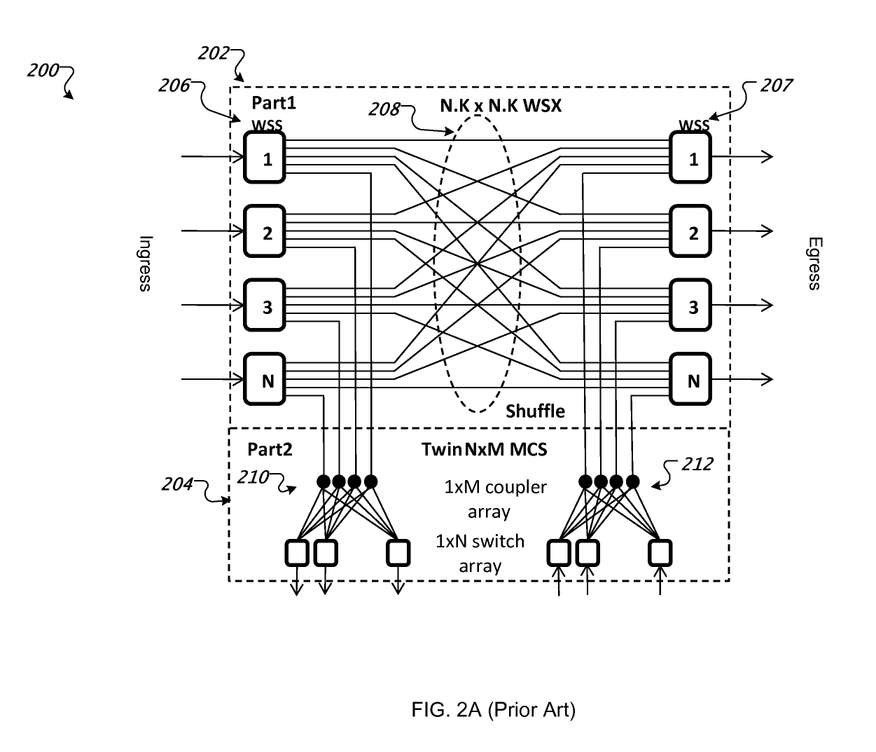

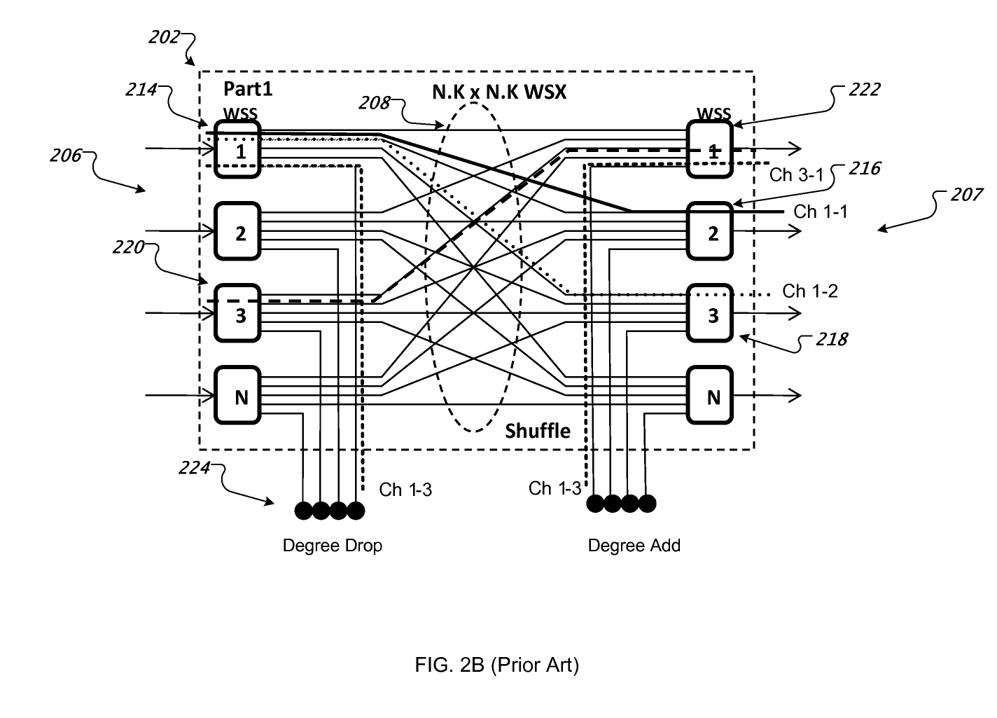

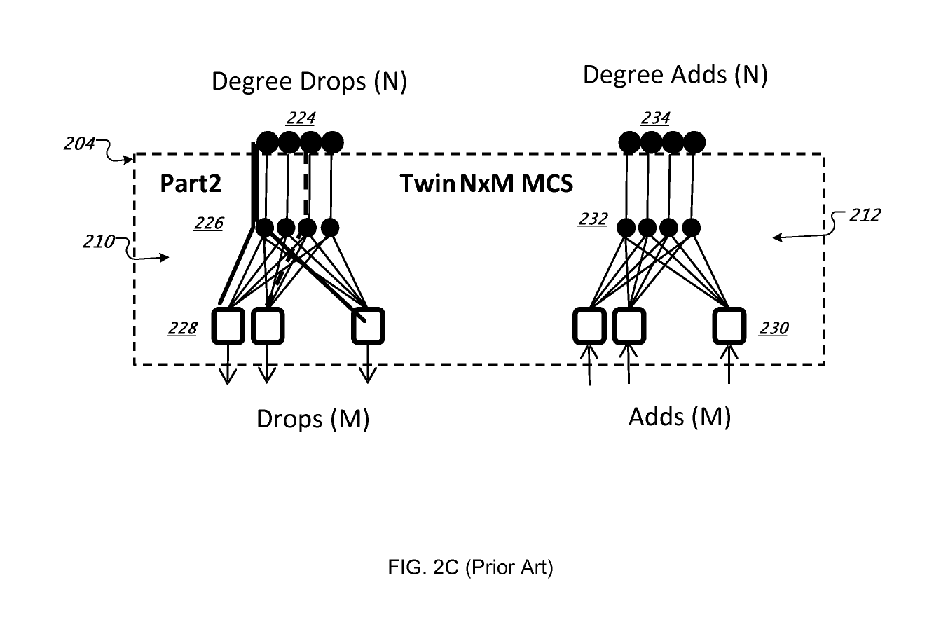

FIG. 2A is a diagram of an example conventional N-degree WSX ROADM 200. The N-degree WSX ROADM 200 includes a first part, which is an N.K×N.K WSX 202. The N.K×N.K WSX 202 has N degrees and K add/drop pairs. In some implementations, K=L×N where L is a natural number. The N.K×N.K WSX 202 includes 2N units of 1×n wavelengths selective switches (WSS) 206/207, an N²×N² fiber shuffle 208 that cross-connects ports of the N ingress WSS's 206 with ports of the N egress WSS's 207; and a twin LN×LN fiber shuffle when L>1 that couples (L) ports of each ingress WSS 206 to L degree drop groups and couples (L) ports of each egress WSS 207 to L degree add groups. J.

The N-degree WSX ROADM 200 also includes a second part, which is a twin N×M multi-cast switch (MCS) 204 where N is the number of degrees and M is the number of add/drop pairs. The twin N×M MCS 204 includes two separate N×M MCS, a first N×M MCS 210 for drop and a second N×M MCS 212 for add. Each N×M MCS includes N units of 1×M splitters, M units of 1×N switch, and an NM×NM fiber shuffle to cross-connect the splitters and switches.

Acting in combination, each add/drop group from the N.K×N.K WSX 202 is linked to one of the twin N×M MCS 204 to provide M CDC add/drop so that the N-degree WSX ROADM 200 can support N degree wavelength selective cross-connect and L×M channel CDC add/drop.

FIG. 2B is a diagram of the example N.K×N.K WSX 202 of FIG. 2A. In particular, FIG. 2B illustrates example paths for wavelength channels through the N.K×N.K WSX 202. Each ingress WSS 206 includes a common port and n branch ports where n=N+L. Any wavelength channel from the common port can be switched to any one of the n branch ports. The N optical branches of each ingress WSS 206 are used to form the WSX and the remaining L optical branches of each ingress WSS 206 are for dropping wavelength channels. Similarly, each egress WSS 207 includes n optical branch ports where n=N+L. The N optical branches of each egress WSS 207 are also used to form the WSX and the remaining L optical branch ports of each egress WSS 207 are for adding wavelength channels. With the N²×N² fiber shuffle providing cross-connections, each of N branch port of each ingress WSS 206 is linked to one of N branch port of each egress WSS 207.

In operation, an optical signal having multiple wavelength channels enters the first ingress WSS 214. The channel can be switched to a particular egress port of an egress WSS 207 and can exit the WSX 202 through a common port of the egress WSS. In particular, FIG. 2B shows the wavelength channel 1-1 being switched to a second egress WSS 216.

Similarly, another wavelength channel from the first ingress WSS 214, wavelength channel 1-2, can be switched to the same or a different egress port. In particular, the example shown in FIG. 2B shows the wavelength channel 1-2 being switched to a third egress WSS 218.

The same wavelength channel as wavelength channel 1-1 received at the first ingress WSS 214 can also be received at another ingress WSS 206. In particular, the example shown in FIG. 2B shows wavelength channel 3-1 received at the third ingress WSS 220 and switched to a first egress WSS 222.

Additionally, a wavelength channel from a particular port of an ingress WSS 206 can be switched to drop. That same wavelength channel can be added from an add port and switched to a particular port of an egress WSS 207. In particular, the example shown in FIG. 2B shows wavelength channel 1-3 received at the first ingress WSS 214 routed to drop 224. This same wavelength channel is then added and routed to the first egress WSS 222.

FIG. 2C is a diagram of the example twin N×M MCS 204 of FIG. 2A. The twin N×M MCS 204 includes two separate N×M MCS's, a first N×M MCS 210 for drop and a second N×M MCS 212 for add. Each N×M MCS includes N units of 1×M splitters, M units of 1×N switch, and an NM×NM fiber shuffle to cross connect the splitters and the switches.

For each N degree drop 224, there are one or more wavelength channels M. A wavelength channel from a degree drop 224 is distributed to each switch 228 by a splitter 226. In some implementations, a particular drop port can be identified and the switch is linked to that drop port. Another wavelength channel from the same degree drop can also be received and switched to drop to another drop port. Additionally, another wavelength channel with the same wavelength but different degree drop can be linked to a switch that directs the wavelength channel to a different drop port.

In reverse, a wavelength channel added from a particular add port to a switch 230 can be routed to a specified coupler 232 and on to a particular degree add 234. Similarly, a wavelength channel with the same wavelength can be routed to a different degree add. Each degree add can receive zero or multiple wavelength channels depending on the switching state.

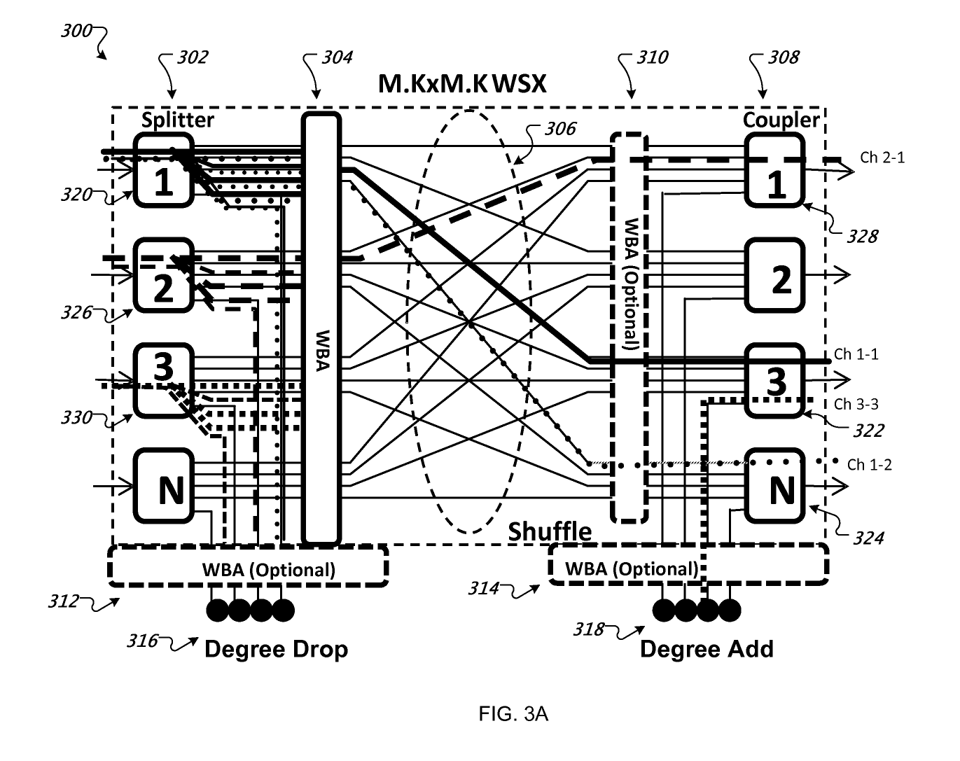

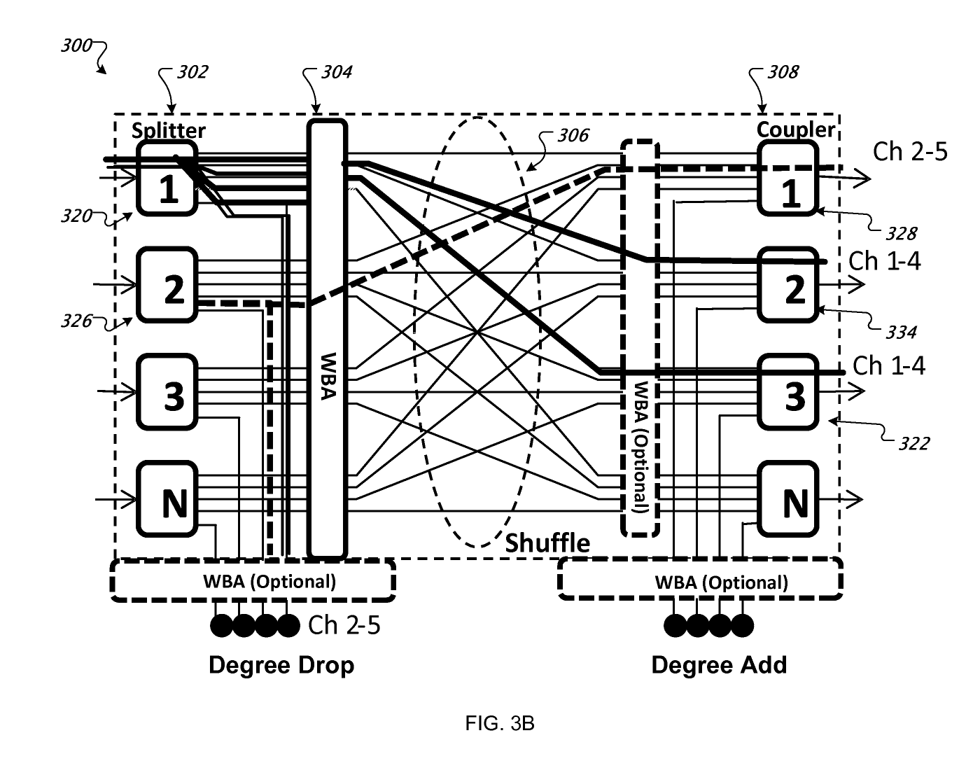

FIG. 3A is a diagram of an example N.K×N.K WSX 300. The N.K×N.K WSX 300 includes N units of 1×n splitters 302 on the ingress side where n=N+1. The first N branches of each splitter 302 are designated for wavelength cross-connect providing a total of N² ingress branches. One additional branch from each splitter 302 is designated for degree drop. Thus, there are N total drop branches from the N splitters 302.

The N.K×N.K WSX 300 also includes a wavelength blocker array (WBA) 304. The WBA 304 includes two or more wavelength blocker units, each operating independently. Each wavelength blocker unit includes at least one input port and an output port. In some implementations, an input port of each wavelength blocker unit is coupled to drop branches of the N units of 1×n splitters. There can be one or more wavelength channels received in input and each wavelength can be set as open, attenuated, or blocked by the particular wavelength blocker. The wavelength blocker is used to demultiplex the input signals, attenuate each signal independently at a value, then re-multiplex them into output signal. The attenuation of each wavelength channel can vary between two extreme statuses, one is called “pass” when the attenuation ratio is set as minimum value, the other is called block when is set as maximum value. The WBA 304 includes N(n) wavelength blocker units where n≥N. In some implementations, n=N such that the WBA 304 includes N² wavelength blocker units where each wavelength blocker unit has an input port corresponding to an ingress branch of a particular splitter 302.

On the egress side, the N.K×N.K WSX 300 also includes N units of n×1 combiners 308 where n=N+1. The first N branches of each coupler 308 are designated for wavelength cross-connect providing a total of N² egress branches. One additional branch from each coupler 308 is designated for providing a degree add. Thus, each combiner 308 has N total branches. The branches from each combiner 308 can be combined to a single output port.

The N.K×N.K WSX 300 also includes a N²×N² fiber shuffle 306. The fiber shuffle 306 provides cross-connect between the N² ingress branches, by way of the N² outputs of the WBA 304, and the N² egress branches such that each branch of an ingress splitter 302 is linked to a branch of each egress combiner 308. In some alternative implementations, the fiber shuffle is an M×M′ fiber shuffle where one or more of M or M′ may be equal to N² or may be some other suitable value. The remaining description of the WSX 300 is similarly applicable to an M×M′ fiber shuffle implementation.

In some implementations, a second WBA 310 is also included in the N.K×N.K WSX 300 between the N²×N² fiber shuffle 306 and the egress couplers 308. This can provide additional wavelength channel filtering or attenuation. Additionally, in some other implementations, one or more additional WBAs 312 or 314 can be included. In particular, the WBA 312 is positioned between the WSX 300 and the degree drop 316 and the WBA 314 can be positioned between the WSX 300 and the degree add 318. In some implementations, the first WBA 304 includes an input port coupled to the drop branches of the N units of 1×n splitters and the second WBA 310 is coupled to the add branches of the N units of n×1 combiners.

Moreover, in some alternative implementations, a single WBA can be positioned either as WBA 304 or WBA 310. That is, a single WBA can be positioned on either side of the N²×N² fiber shuffle 306. The WBA can perform the same functions regardless of which side of the N²×N² fiber shuffle 306 it is placed.

In operation, there are one or more wavelength channels received at respective ingress ports of the splitters 302. A wavelength channel from an ingress is split and distributed to N branches. Each of the N branches of the ingress is input to the WBA 304. Based on the specified cross-connect route for the wavelength channel, the particular WB unit will set the wavelength channel open and let it pass while the other WB's for the split branches will block the wavelength channel from output. The optical signal for the passed wavelength channel is routed by the fiber shuffle 306 to a particular egress combiner 308 and from there to an egress port.

For example, a wavelength channel (ch. 1-1) received at a first splitter 320 of the splitters 302 is separated into N branches, each passed to the WBA 304. A passed signal from a particular WB unit of the WBA 304 can be routed, in this example, to a third coupler 322 of the egress couplers 308. In another example, a different wavelength channel (ch. 1-2) received at the first splitter 320 can be passed by a different WB of the WBA 304 and routed, in this example, to a fourth coupler 324.

In another example, a same wavelength channel as the wavelength channel 1-1 can be received at a second splitter 326 (ch. 2-1). Although it has the same wavelength, it is routed to different wavelength blockers of the WBA 304 and therefore can be routed to a different egress port. In this example, the passed signal of ch. 2-1 is routed to a first coupler 328.

Furthermore, a wavelength channel from an ingress port is also split to a drop branch and routed to its corresponding degree drop port. In some implementations, the wavelength channel is blocked by all WB's of the WBA 304. For the example shown in FIG. 3, a wavelength channel (ch. 3-3) received at a third splitter 330 is blocked by the WBA 304 and dropped at its degree drop port. The same wavelength channel can optionally be added from a specified degree add port and routed to a corresponding egress coupler 308, which in the example shown is the third coupler 322.

FIG. 3B is a diagram of the example N.K×N.K WSX 300 of FIG. 3A with additional wavelength channel routing. In particular, the N.K×N.K WSX 300 can be used to provide broadcast functionality. In particular, a wavelength channel received at a particular ingress splitter 302 can be broadcast to two or more egress ports. The WBA 304 can include two or more open wavelength blockers for the branches received from the particular splitter. Consequently, the optical signal for the wavelength channel can be routed to two more couplers 308.

Specifically, as shown in FIG. 3B, a wavelength channel (ch. 1-4) received at the first splitter is passed by more than one wavelength blocker in the WBA 304. Each passing wavelength blocker routes the passed optical signal through the fiber shuffle 306 to a different coupler 308, namely a second coupler 334 and the third coupler 322. Therefore, the wavelength channel is broadcast from the first ingress port to two egress ports.

The N.K×N.K WSX 300 can also provide drop and continue functionality. In particular, a wavelength channel received at a particular ingress splitter 302 can be passed by one or more wavelength blockers in the WBA 304 while also being dropped to a degree drop port. For example, as shown in FIG. 3B, a wavelength channel (ch-2-5) received at the second splitter 326 is routed by a drop branch to the degree drop port as well as passed by the WBA 304 to the first coupler 328.

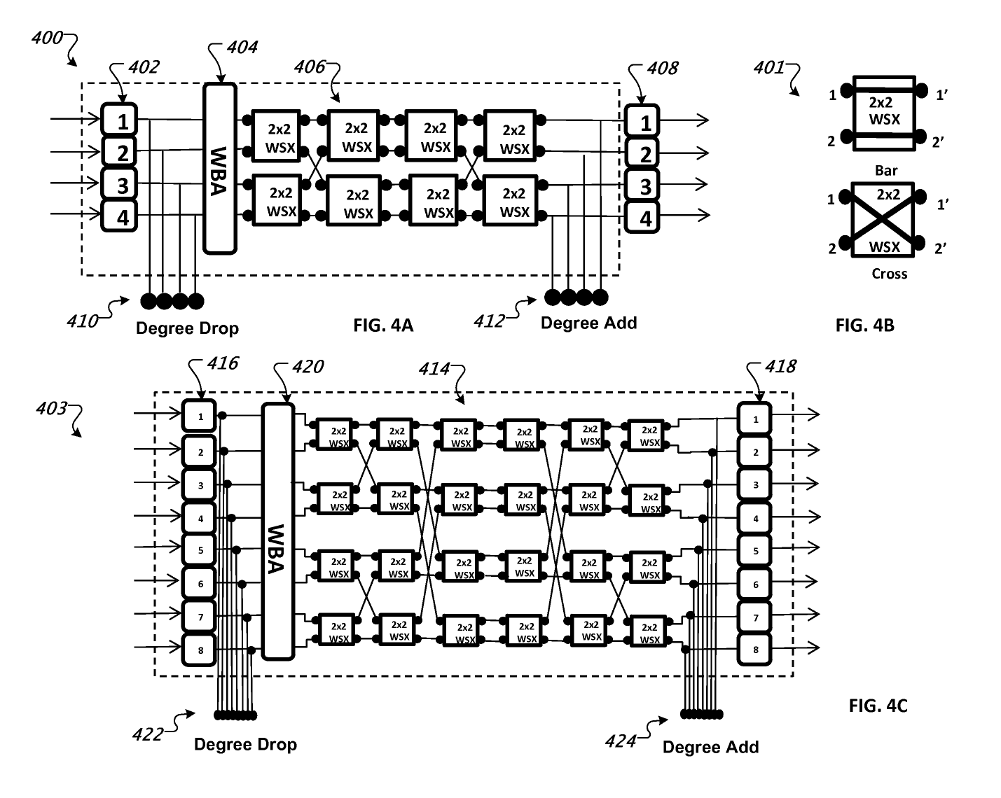

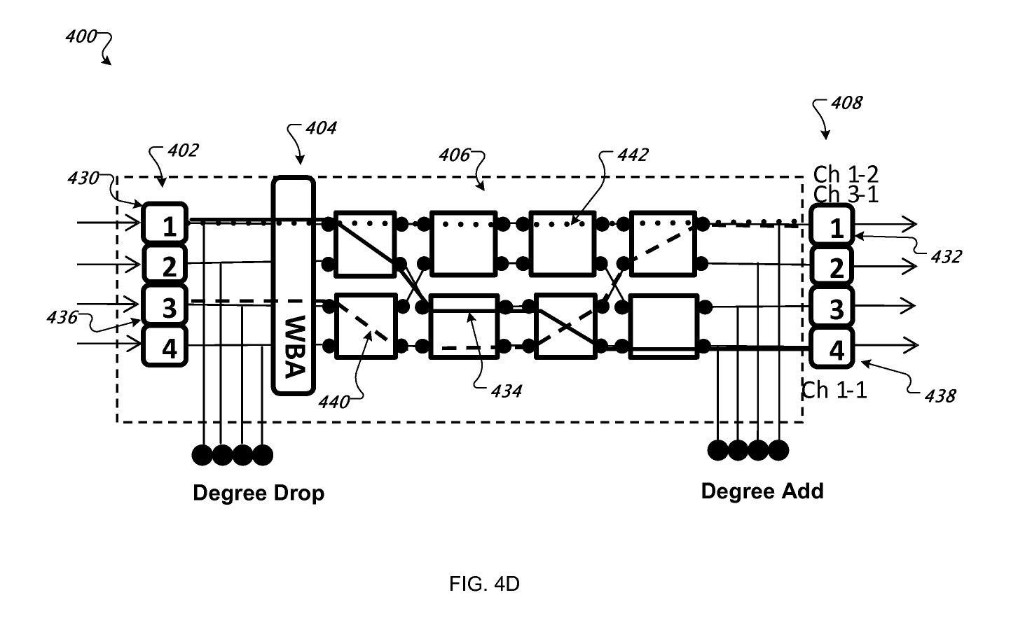

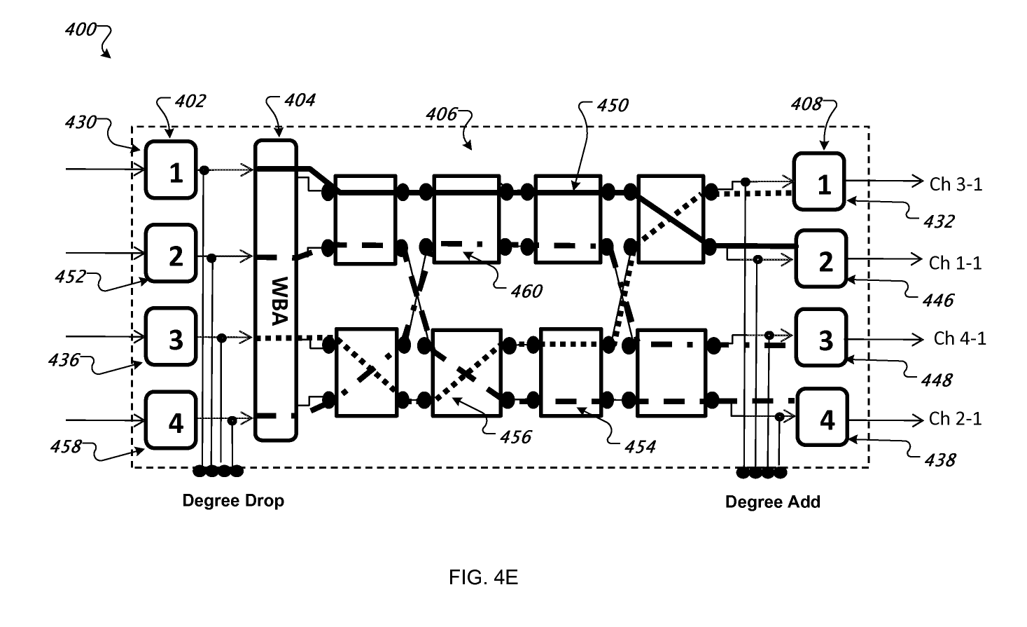

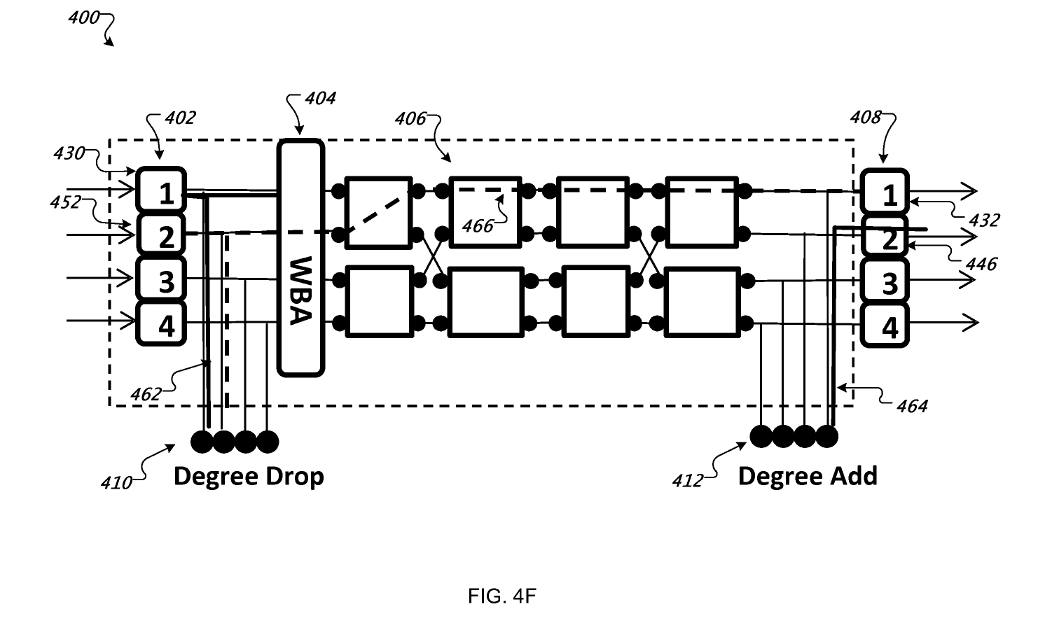

FIG. 4A is a diagram of an example 4.4×4.4 WSX 400 using a 2×2 WSX array 406. The WSX 400 includes four 1×2 tap couplers 402 on an ingress side, four 2×1 tap couplers 408 on an egress side, a wavelength blocker array (WBA) 404, and the WSX array 406. Each of the tap couplers 402 includes an input for receiving a signal and a tapped output. The tapped portion of the output is routed to a port of a degree drop 410. Each of the tap couplers 408 combines an input from the WSX array 406 and an input from a particular port of a degree add 412, and provide the combined signal as an output. The WBA 404 functions similarly to that of the WBA 304 in FIGS. 3A-B. In the example shown in FIG. 4A, the WBA 304 includes four units of wavelength blockers, one for each ingress tap coupler 402.

The WSX array 406 includes eight 2×2 WSX's, each controlled independently. Each 2×2 WSX has two input ports and two output ports. Each 2×2 WSX can be independently controlled to be in either a bar state or a cross state.

FIG. 4B is a diagram showing an example of bar and cross states of a 2×2 WSX 401. In the bar state of the 2×2 WSX 401, input from a first port 1 is routed to a first output port 1′ and input from a second port 2 is routed to a second output port 2′. However, in the cross state of the 2×2 WSX 401, input from the first port 1 is routed to the second output port 2′ and input from the second port 2 is routed to the first output port 1′.

FIG. 4C is a diagram of an example 8.8×8.8 WSX 403 using a 2×2 WSX array 414. The WSX 403 is similar to the WSX 400 but scaled up in size. In particular, the WSX 403 includes eight 1×2 tap couplers 416 on an ingress side, eight 2×1 tap couplers 418 on an egress side, a wavelength blocker array (WBA) 420, and the WSX array 414. Each of the tap couplers 416 includes an input for receiving a signal and a tapped output. The tapped portion of the output is routed to a port of a degree drop 422. Each of the tap couplers 418 combines an input from the WSX array 414 and an input from a particular port of a degree add 424, and provide the combined signal as an output. The WSX array 414 includes twenty-four 2×2 WSX's, each controlled independently. Each 2×2 WSX has two input ports and two output ports. Each 2×2 WSX can be independently controlled to be in either a bar state or a cross state.

FIG. 4D is a diagram of the example 4.4×4.4 WSX of FIG. 4A including example path routing. Each ingress port to the tap couplers 402 can receive one or more wavelength channels. In one example, a wavelength channel received at a first ingress tap coupler 430 (ch. 1-1) is tapped a portion to the degree drop while the remaining passes to the WBA 404. If the wavelength channel is open for the corresponding wavelength blocker, the wavelength channel passes through a series of 2×2 WSX having switch settings, e.g., bar or cross states, that route the wavelength channel to the specified egress port at the first egress tap coupler 432. In particular, the path is illustrated by solid line 434 showing that the wavelength channel passes through four 2×2 WSX's for a particular switch setting of the WSX array 406, e.g., a particular combination of bar and cross states specified for WSX switches.

In another example, another wavelength channel having the same wavelength enters through an ingress port at a third ingress tap coupler 436 (ch. 3-1). This wavelength channel is switched to a different egress port at a fourth egress tap coupler 438 using the 2×2 WSX array 406 in the same switch setting. The path of the wavelength channel is shown by the dashed line 440.

Another wavelength channel received at the first ingress tap coupler 430 (ch. 1-2) can be switched to the same egress port as ch. 1-1 or can be routed to a different egress port according to a different switch setting. As shown in FIG. 4D, the dotted path 442 shows a second switch setting in which ch. 1-2 is routed to the first egress tap coupler 432.

Thus, each wavelength channel can be set as a bar or cross state independently such that different wavelengths from one ingress can have different settings. However, a same wavelength from two input ports of a 2×2 WSX have to have the same switching state, either both bar or both cross.

FIG. 4E is a diagram of the example 4.4×4.4 WSX 400 of FIG. 4A including example path routing. In particular, FIG. 4E illustrates a non-blocking switch in which one switching setting allows a same wavelength from different ingress ports to different egress ports concurrently. In FIG. 4E a wavelength channel (Ch. 1-1) is input at the first ingress tap coupler 430 and routed to the second egress tap coupler 446, as illustrated by path 450. The same wavelength channel input at the second ingress tap coupler 452 (Ch. 2-1) is routed to the fourth egress tap coupler 438, as illustrated by path 454. The same wavelength channel input at the third ingress tap coupler 436 (Ch. 3-1) is routed to the first egress tap coupler 432, as illustrated by path 456. Finally, the wavelength channel input at a fourth ingress tap coupler 458 (Ch. 4-1) is routed to the third egress tap coupler 448, as illustrated by path 460.

FIG. 4F is a diagram of the example 4.4×4.4 WSX 400 of FIG. 4A including example path routing. In particular, FIG. 4F shows an example of add/drop functionality in the WSX 400. In some implementations, a wavelength channel input at a particular ingress tap coupler has a portion of the signal tapped to a port of the degree drop 410. The wavelength channel can then be blocked by the WBA 404 or can be passed by the WBA 404 to provide drop-and-continue. As shown in FIG. 4F, a wavelength channel is received at the first ingress tap coupler 430 (Ch. 1-1). As illustrated by solid path 462, a portion is tapped to the degree drop 410 while the remaining signal of the wavelength channel is blocked by the WBA 404. Additionally, however, the wavelength channel is input from a port of the degree add 412 and routed to the second egress tap coupler 446, as shown by the solid path 464. Thus, the wavelength channel is dropped and then added again.

Additionally, FIG. 4F illustrates the drop-and-continue. A wavelength channel input at the second input tap coupler 452 (Ch. 2-1) has a portion tapped to the degree drop 410. At the same time, the WBA 404 allows the wavelength channel to pass through the WSX array 406 to the first egress tap coupler 432. The path through the switch setting of the WSX array 406 is shown by dotted line 466.

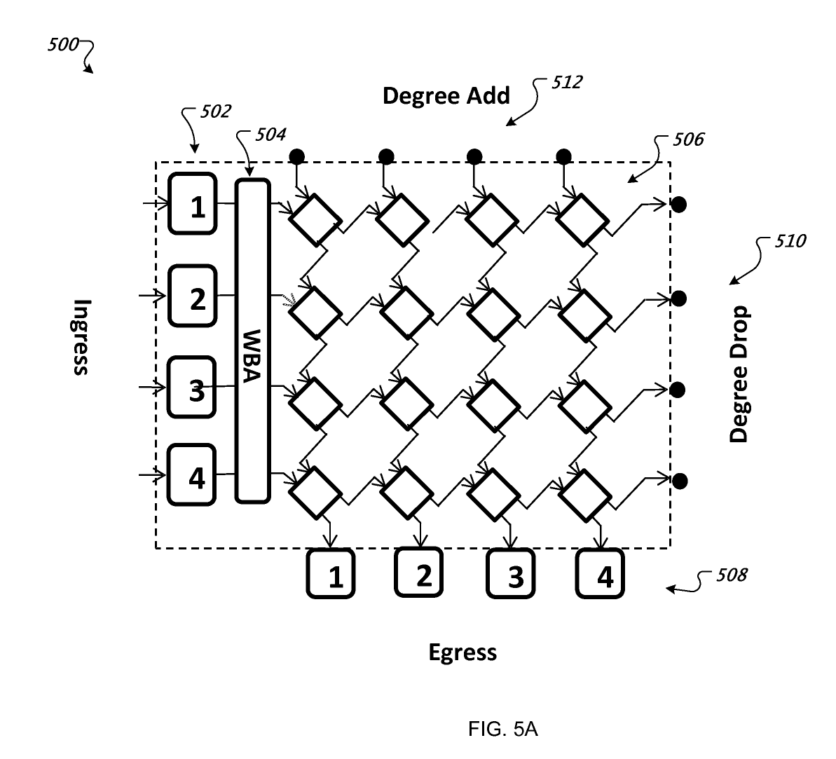

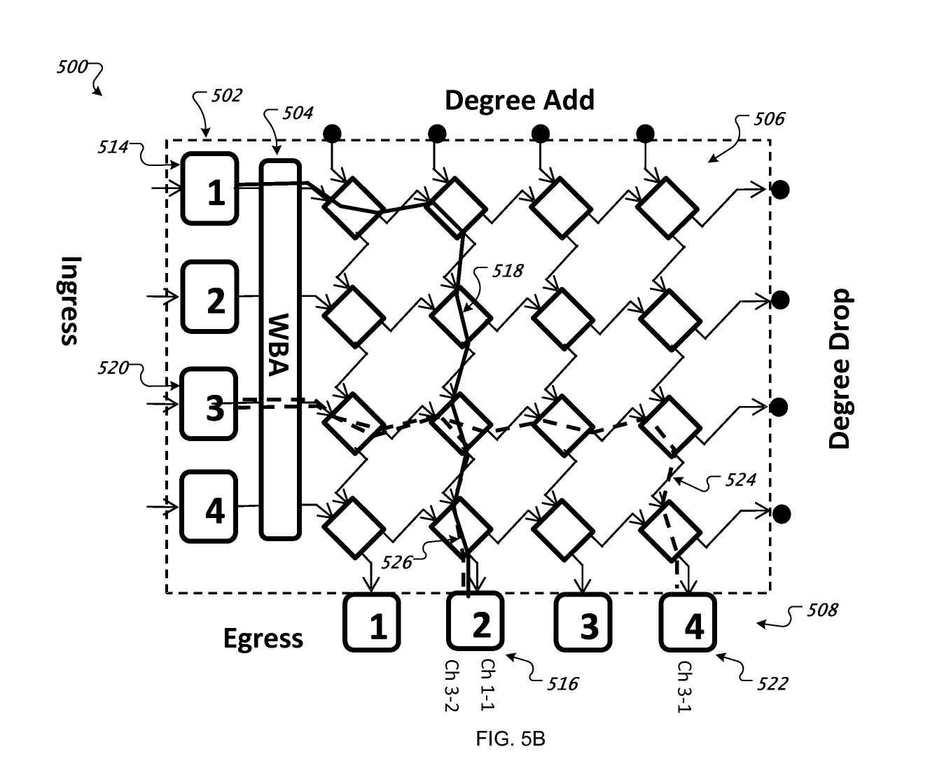

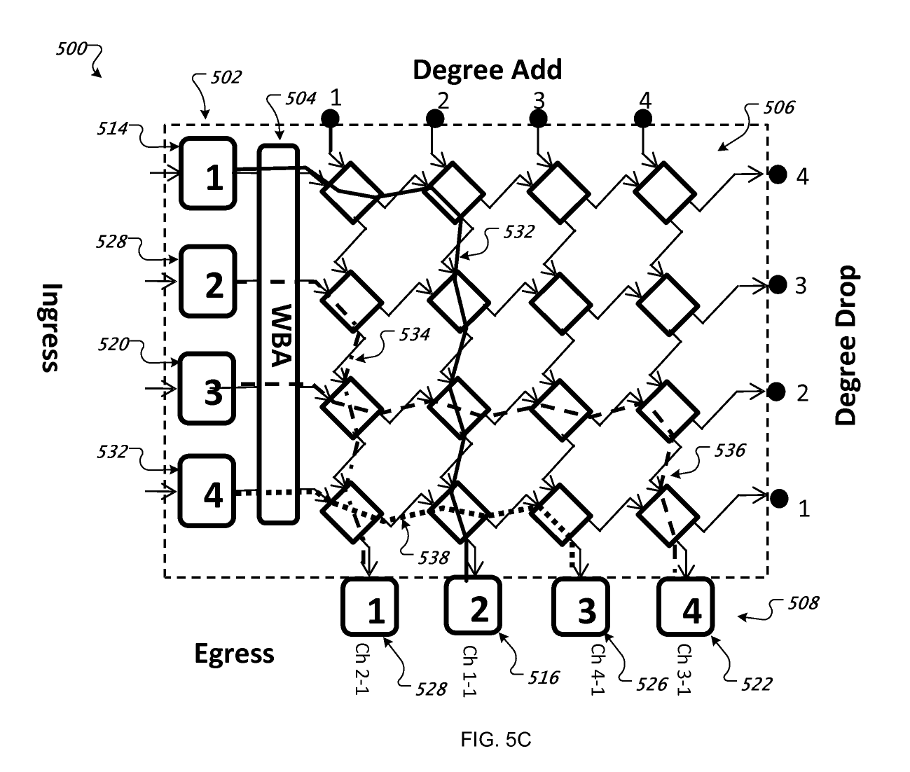

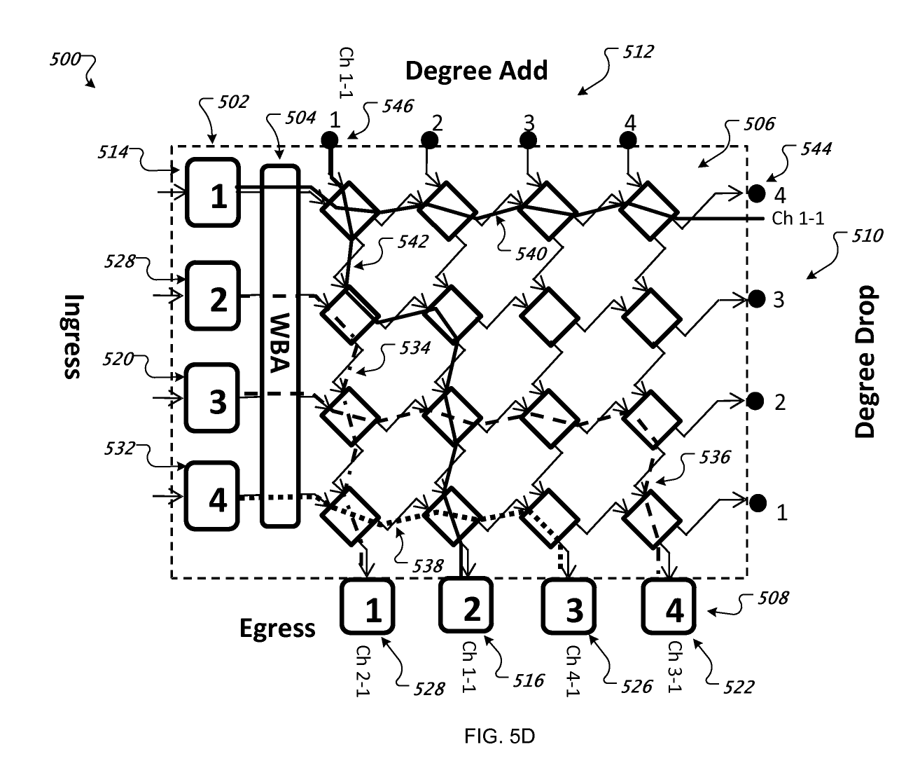

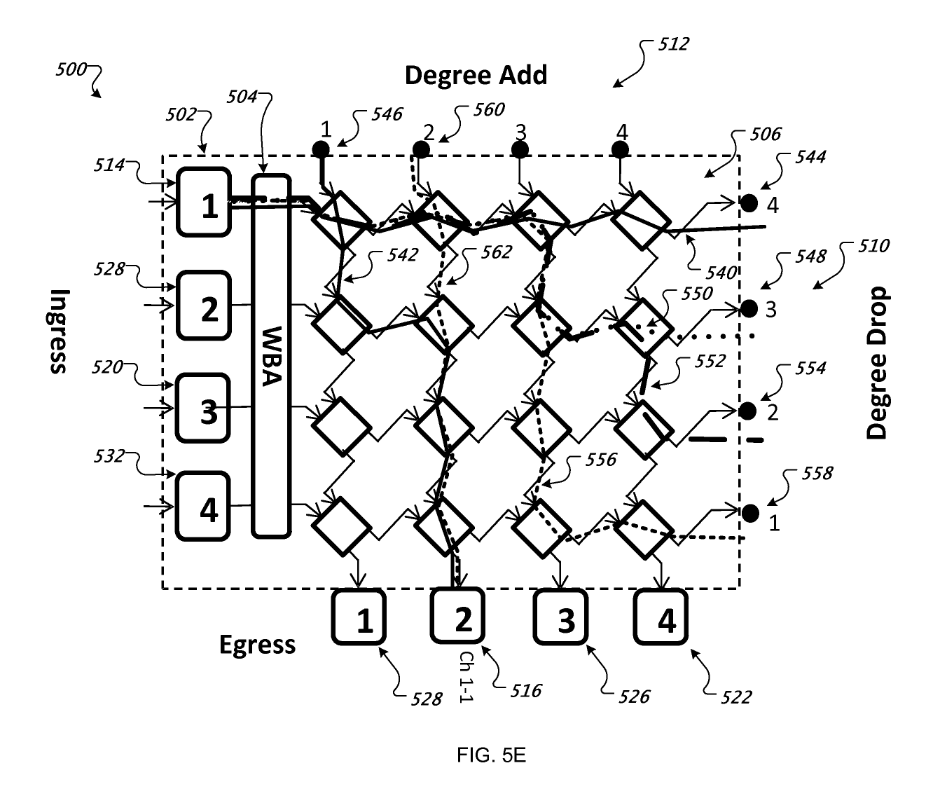

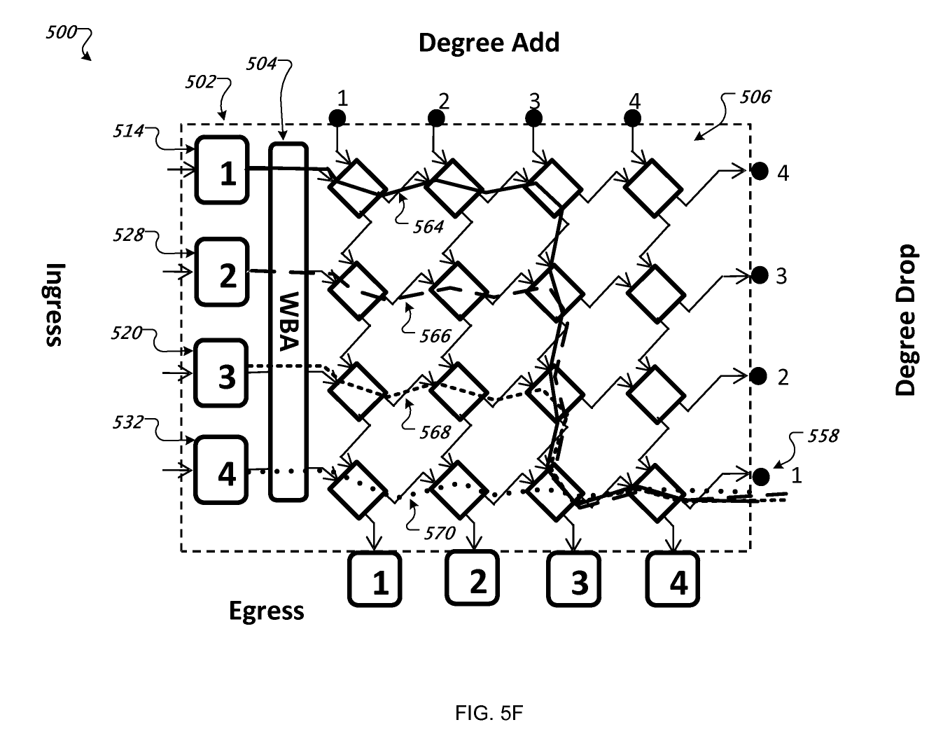

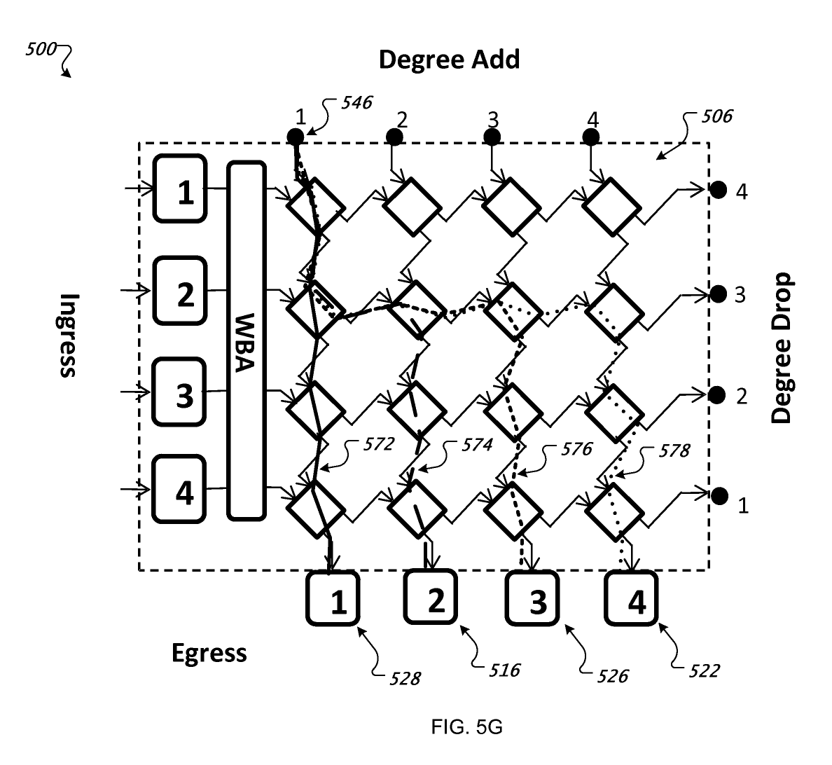

FIG. 5A is a diagram of an example N.K×N.K WSX 500. The WSX 500 includes ingress ports 502, a WBA 504, a 2×2 WSX array 506, egress ports 508, degree drop ports 510, and degree add ports 512.

In particular, there are N ingress ports, each coupled to the WBA 504. The WBA 504 is similar to the WBA 404 described above and includes N wavelength blocker units that can selectively pass, block, or attenuate particular wavelength channels. The 2×2 WSX array 506 includes N² or in this example 16, 2×2 WSX's, each controlled independently. Other implementations can include a different number of 2×2 WSX's in the WSX array. Each 2×2 WSX has two input ports and two output ports. Each 2×2 WSX can be independently controlled to be in either a bar state or a cross state. The bar and cross states for a 2×2 WSX were described above with respect to FIG. 4B.

The lattice arrangement of the 2×2 WSX's in the 2×2 WSX array 506 provide for routing wavelength channels passed by the WBA 504 to any one of the egress ports 508, or particular degree drop 510. Additionally, the 2×2 WSX array 506 is configured to allow an input add wavelength channel from one or more of the degree add ports 512 and route the added signal to one of the egress ports 508.

FIG. 5B is a diagram of the example N.K×N.K WSX 500 of FIG. 5A including example path routing. In particular, as with the examples above, each ingress port 502 can receive one or more wavelength channels. A wavelength channel that passes through the WBA 504 then passes through a series of 2×2 WSX's having a particular switch setting such that the signal of the wavelength channel is routed to a particular egress port 508. For example, FIG. 5B shows a wavelength channel received at a first ingress port 514 (Ch. 1-1). After passing through the WBA, the signal of the wavelength channel is routed through a series of 2×2 WSX's to a second egress port 516. The path of the wavelength channel Ch. 1-1 is shown by path 518.

In another example, a wavelength channel having the same wavelength is input at a third ingress port 520 (Ch. 3-1). This wavelength channel also passes through a series of 2 2 WSX's in the 2×2 WSX array 506 to a fourth egress port 522 according to the same switch setting. The path of the wavelength channel Ch. 3-1 is shown by dashed path 524.

The path of a given wavelength channel through the 2×2 WSX array 506 varies depending on the switching setting of the array. For example, a second wavelength channel received at the third ingress port 520 (Ch. 3-2) can be routed to the same fourth egress port 522. However, under a different switch setting, the signal of the wavelength channel Ch. 3-2 can be routed to a different egress port. As shown in the example of FIG. 5B, under a second switch setting, the wavelength channel 3-2 is routed to the second egress port 516, as illustrated by dashed line 526.

FIG. 5C is a diagram of the example N.K×N.K WSX 500 of FIG. 5A including example path routing. In particular, FIG. 5C illustrates a non-blocking switch in which one switching setting allows a same wavelength from different ingress ports to different egress ports concurrently. In FIG. 5C a wavelength channel (Ch. 1-1) is input at the first ingress port 514 and routed to the second egress port 516, as illustrated by path 532. The same wavelength input at the second ingress port 528, wavelength channel (Ch. 2-1) is routed to the first egress port 524, as illustrated by path 534. The same wavelength channel input at the third ingress port 520 (Ch. 3-1) is routed to the fourth egress port 522, as illustrated by path 536. Finally, the wavelength channel input at a fourth ingress port 530 (Ch. 4-1) is routed to the third egress port 526, as illustrated by path 538.

FIG. 5D is a diagram of the example N.K×N.K WSX 500 of FIG. 5A including example path routing. In particular, FIG. 5D shows an example of add/drop functionality in the WSX 500. In particular, the example of FIG. 5D shows that the paths of wavelength channels received at the second, third, and fourth ingress 528, 520, and 532 are unchanged from that shown in FIG. 5C.

However, the wavelength channel received at the first ingress port 514 (Ch. 1-1) is directed to a degree drop port 544, as illustrated by path 540. A new signal of the same wavelength is input from a degree add port 546 and directed through the WSX array 506 to the second egress port 516 as illustrated by path 542.

FIG. 5E is a diagram of the example N.K×N.K WSX 500 of FIG. 5A including example path routing. In particular, FIG. 5E illustrates the flexibility of the WSX 500 using the WSX array 506. As was shown in FIG. 5D, the wavelength channel received at the first ingress port 514 (Ch. 1-1) can be routed to the degree drop port 544 along path 540 and a new wavelength can be input from a degree add port 546 and directed through the WSX array 506 to the second egress port 516 along path 542.

The WSX array 506 can also be used to route the wavelength channel ch. 1-1 to different drop ports. In particular, the wavelength channel input at the first ingress port 514 can be routed by the WSX array 506 to degree drop port 548 along path 550, to degree drop port 554 along path 552, and to degree drop port 558 along path 556.

Similarly, the same wavelength channel can be added at a different degree add port. As shown in FIG. 5E, the wavelength channel is added at degree add port 560 while remaining routed by the WSX array 506 to the second egress port 516 along path 562.

FIG. 5F is a diagram of the example N.K×N.K WSX 500 of FIG. 5A including example path routing. In particular, FIG. 5F illustrates an example of the directionless drop provided by the WSX 500. As shown in FIG. 5F, using a particular switch setting, a wavelength channel from any ingress port can be routed to the same degree drop port. Thus, a wavelength channel received the first ingress port 514 is routed along path 564 through the WSX array 506 to degree drop port 558. A wavelength channel received at the second ingress port 528 is routed along path 566 through the WSX array 506 to the degree drop port 558. A wavelength channel received at the third ingress port 520 is routed along path 568 through the WSX array 506 to degree drop port 558. Finally, a wavelength channel received at the fourth ingress port 532 is routed along path 570 through the WSX array 506 to degree drop port 558.

FIG. 5G is a diagram of the example N.K×N.K WSX 500 of FIG. 5A including example path routing. In particular, FIG. 5F illustrates an example of the directionless add provided by the WSX 500. As shown in FIG. 5F, using a particular switch setting, a wavelength channel added at a particular degree add port can be routed to any egress port. Thus, a wavelength channel received at the degree add port 546 can be selectively added according to a corresponding switch setting to the first egress port 528 along path 572, to the second egress port 516 along path 574, to the third egress port 526 along path 576, and to the fourth egress port 522 along path 578.

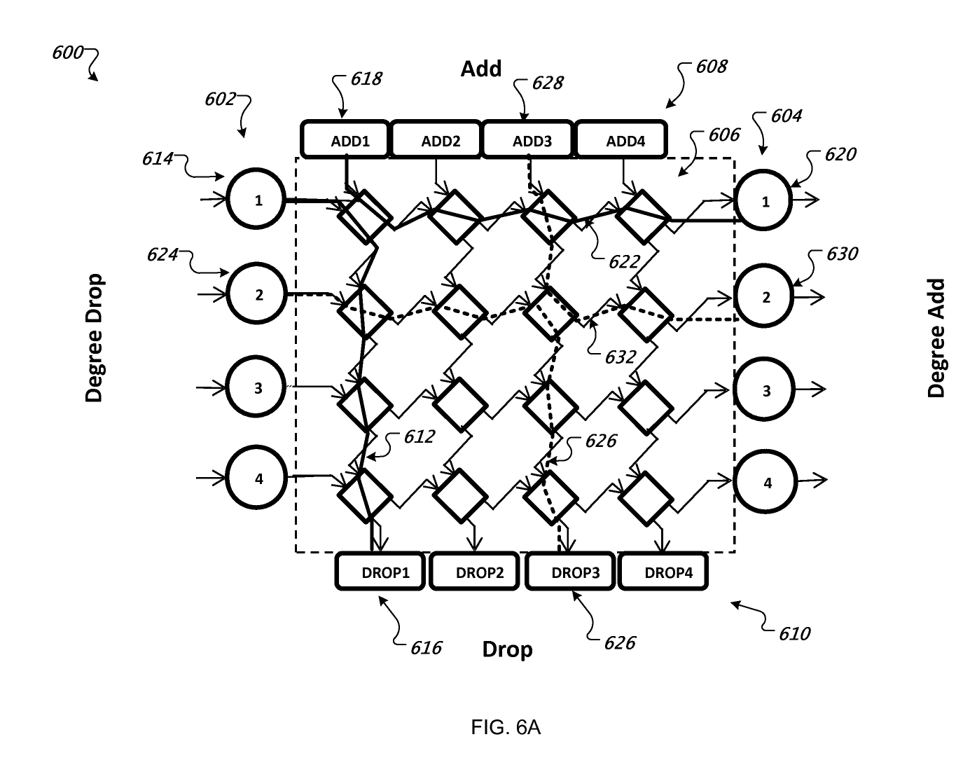

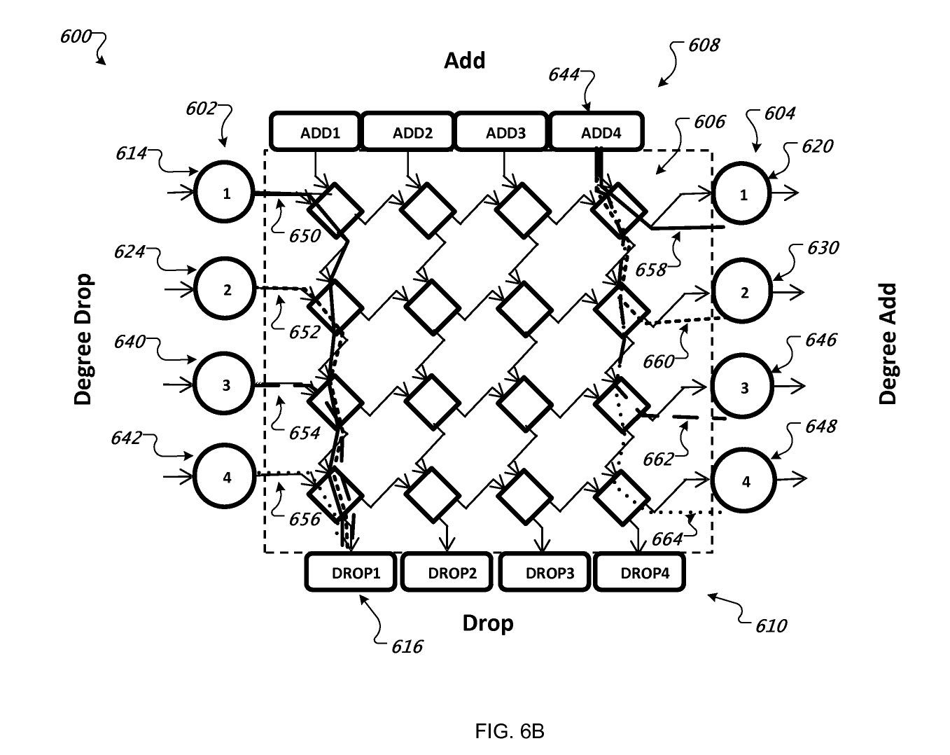

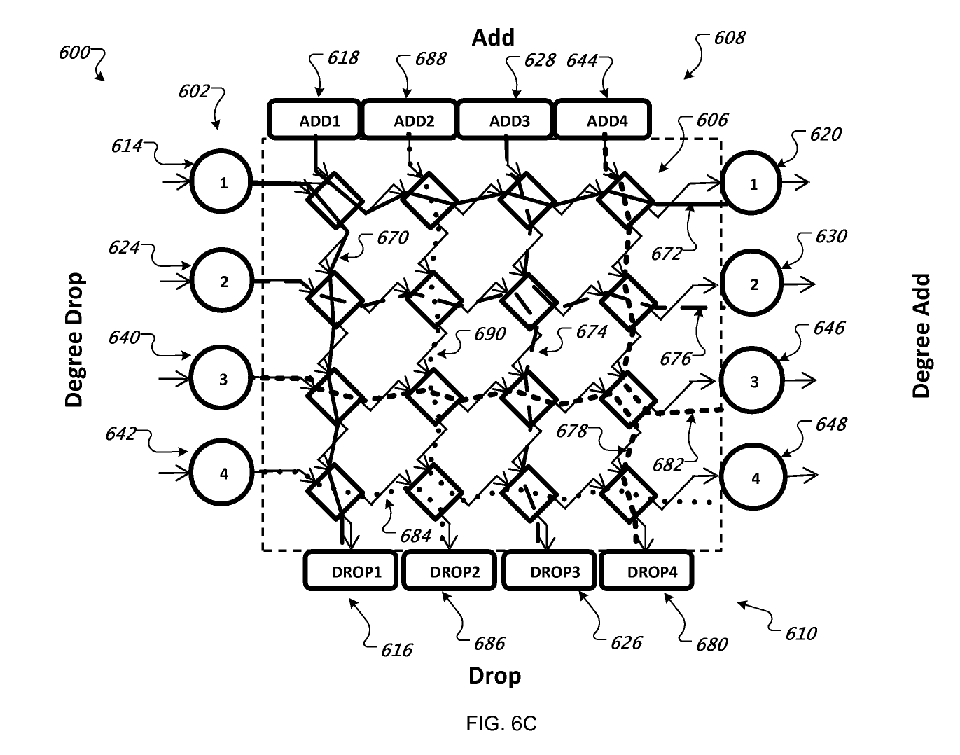

FIG. 6A is a diagram of an example twin N×N CDC add/drop shuffle 600. The add/drop shuffle 600 receives wavelength channels, for example, from the degree drop of a WSX of FIGS. 3-5 and routes particular add wavelength channels to a degree add port to add back into the WSX. The add/drop shuffle 600 includes degree drop ports 602, degree add ports 604, a 2×2 WSX array 606, add ports 608, and drop ports 610.

The 2×2 WSX array 606 is a 2×2 array of 2×2 WSXs. In some implementations, there are N² units of 2×2 WSXs. One or more wavelength channels can be received from each degree drop port 602. For example, each degree drop port 602 can correspond to a particular degree drop from a WSX such as shown in FIGS. 3-5 where wavelength channels can be selectively routed to a particular degree drop port. A particular wavelength channel (Ch. 1-1) received from a degree drop port 602 can be routed through a series of the 2×2 switches in the 2×2 WSX array 606 to a particular drop port 610. Path 612 illustrates the path of a wavelength channel received at a first degree drop 614 and routed to a first drop port 616. Additionally, a channel having the same wavelength can be input from a first add port 618 and routed through the 2×2 WSX array 606 to a particular degree add port 620 along path 622.

Similarly, another wavelength channel (Ch. 2-1) having the same wavelength as Ch. 1-1 can be received from a second degree drop port 624 and routed to a third drop port 626 along path 628. The same wavelength can be input from a third add port 628 and routed to a second degree add port 630 along path 632 through the 2×2 WSX array 606.

FIG. 6B is a diagram of the example twin N×N CDC add/drop shuffle 600 including example path routing. In particular, FIG. 6B illustrates an example of the directionless add/drop provided by the add/drop shuffle 600. As shown in FIG. 6B, using a particular switch setting, a wavelength channel input from different degree drop ports 602 can be routed to a same drop port and a wavelength from the same add port 608 can be routed to different degree add ports 604. As shown in FIG. 6B, a wavelength channel input at the first degree drop port 614 is routed along path 650 to the first drop port 616. A corresponding wavelength channel is input at the fourth add port 644 and routed along path 658 to the first degree add port 620. A wavelength channel input at the second degree drop port 624 is routed along path 652 to the first drop port 616. A corresponding wavelength channel is input at the fourth add port 644 and routed along path 660 to the second degree add port 630.

A wavelength channel input at a third degree drop port 640 is routed along path 654 to the first drop port 616. A corresponding wavelength channel is input at the fourth add port 644 and routed along path 662 to a third degree add port 646. A wavelength channel input at a fourth degree drop port 642 is routed along path 656 to the first drop port 616 and a corresponding wavelength channel is input at the fourth add port 644 and routed along path 664 to a fourth degree add port 648.

FIG. 6C is a diagram of the example twin N×N CDC add/drop shuffle 600 including example path routing. In particular, FIG. 6C illustrates an example of the contentionless add/drop provided by the add/drop shuffle 600. As shown in FIG. 6C, using a particular switch setting, the same wavelength received from different degree drop ports 602 can be switched to different drop ports 610 while different add ports 608 can add the wavelength to particular degree add ports 604. As shown in FIG. 6C, the wavelength channel received at the first degree drop port 614 is routed along path 670 to the first drop port 616. Additionally, the wavelength channel is added at the first add port 618 and routed along path 672 to the first degree add port 620.

The wavelength channel received at the second degree drop port 624 is routed along path 674 to the third drop port 626. Additionally, the wavelength channel is added at the third add port 628 and routed along path 676 to the second degree add port 630.

The wavelength channel received at the third degree drop port 640 is routed along path 678 to a fourth drop port 680. Additionally, the wavelength channel is added at the fourth add port 644 and routed along path 682 to the second degree add port 646.

The wavelength channel received at the fourth degree drop port 642 is routed along path 684 to a second drop port 686. Additionally, the wavelength channel is added at a second add port 688 and routed along path 690 to the fourth degree add port 648.

Additionally, a different switching setting can be used to provide the colorless add/drop of the add/drop shuffle 600. In particular, under particular switching settings, different wavelength channels can achieve different add/drop patterns.

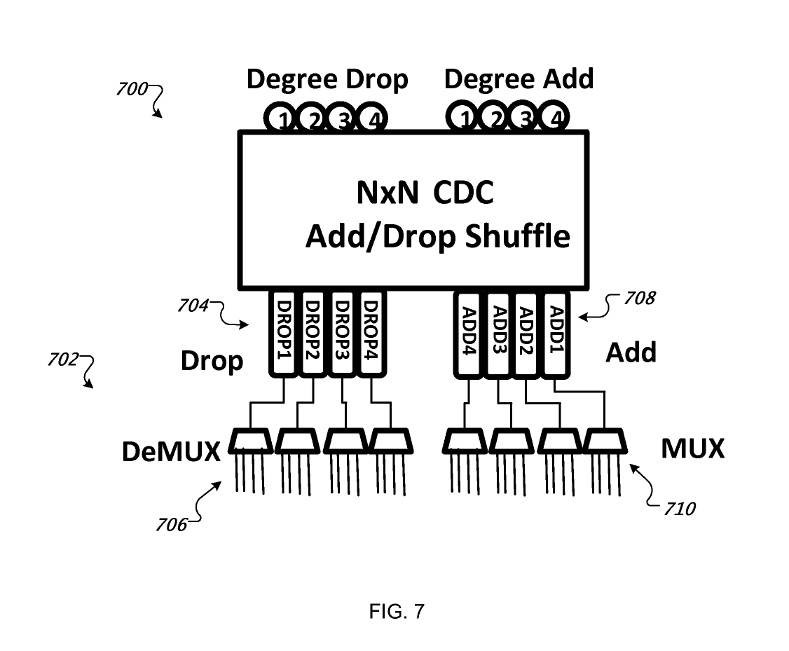

FIG. 7 is a diagram of an example twin N×N CDC add/drop shuffle 700 including splitter extension 702. In particular, the add/drop shuffle 700 can be similar to the add/drop shuffle shown in FIGS. 6A-C. Drop ports 704 from the add/drop shuffle 700 are coupled to Demux 706. Add ports 708 from the add/drop shuffle 700 are coupled to splitter 710. The splitter 702 can be a 1×M splitter. In some other implementations, the splitter 710 can instead be formed by a dense wavelength division multiplexer or a tunable Mux/Demux, e.g., a splitter and tunable filter combination. Since each drop port 704 allows multiple wavelengths and each wavelength can be from a different degree drop, each drop can extent do multiple (M) CDC ports through a splitter/combiner or a tunable Mux/Demux. This can extend to M colored directionless ports through the splitter 702.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An apparatus comprising:
a plurality of ingress ports;
a wavelength blocker array having a plurality of wavelength blocking units, each wavelength blocking unit coupled to a corresponding one of the plurality of ingress ports;
a plurality of egress ports;
a plurality of degree drop ports;
a plurality of degree add ports; and
a wavelength selective cross-connect (WSX) array comprising a plurality of 2×2 independently switched 2×2 wavelength selective cross-connect switches, wherein the WSX array is coupled to the wavelength blocker array, the plurality of egress ports, the plurality of degree drop ports, and the plurality of degree add ports.

2. The apparatus of claim 1, wherein each wavelength blocker unit includes an input port coupled to a corresponding ingress port and an output port coupled to an input port of a particular 2×2 WSX switch.

3. The apparatus of claim 1, wherein each WSX switch includes two input ports and two output ports and wherein each WSX switch is independently controllable to switch between a bar state and a cross state, each switch state determining which input ports are coupled to which output ports.

4. The apparatus of claim 1, wherein based on a particular switch setting for the WSX array, a wavelength channel input to a first 2×2 WSX switch of the WSX array is routed through a series of the 2×2 WSX switches to a specified egress port.

5. The apparatus of claim 1, wherein the WSX array includes sixteen 2×2 WSX switches.

6. The apparatus of claim 1, wherein a same wavelength channel received from different ingress ports are routed by the WSX array to different egress ports concurrently.

7. The apparatus of claim 1, wherein a wavelength channel received at the WSX array from a first ingress port is routed to a degree drop port and a same wavelength channel input at a degree add port is routed by the WSX array to a particular egress port.

8. The apparatus of claim 1, wherein a wavelength channel received at the WSX array from a first ingress port is selectively routed to any one of the degree drop ports depending on a switch setting of the WSX array.

9. The apparatus of claim 1, wherein a wavelength channel received at the WSX array from any of the ingress ports are selectively routed to a same degree drop port.

10. The apparatus of claim 1, wherein a wavelength channel received at the WSX array from a first degree add port is selectively routed to any one of the egress ports depending on a switch setting of the WSX array.
